(19) United States
(12) Patent Application Publication
(10) Pub. No.: US 2018/0087719 A1
(43) Pub. Date: Mar. 29, 2018

(54) GAS CYLINDER

(71) Applicant: Faber Industrie S.p.A., Cividale del Friuli, Udine (IT)

(72) Inventor: Gian Luigi Cola, Cividale del Friuli (IT)

(73) Assignee: Faber Industrie S.p.A., Cividale del Friuli, Udine (IT)

(21) Appl. No.: 15/558,828

(22) PCT Filed: Feb. 26, 2016
(86) PCT No.: PCT/IB2016/051048

§ 371 Date: Sep. 15, 2017

(30) Foreign Application Priority Data
Mar. 17, 2015 (IT) MI2015U000062

(51) Int. Cl. F17C 13/08; F17C 1/14; F17C 13/04

(52) U.S. Cl. CPC F17C 13/08; F17C 1/14; F17C 13/04; F17C 2201/0119; F17C 2201/032; F17C 2203/012; F17C 2203/0617; F17C 2203/0643; F17C 2203/0663; F17C 2205/0165; F17C 2205/0305; F17C 2205/0323; F17C 2203/0646

(57) ABSTRACT

A gas cylinder (1) comprising a cylinder body (2), a supporting part (11) with one or more resting portions (12) protruding towards a lower side (7) of the cylinder (1), a protection ring (13) manufactured separately and then mounted to the supporting part (11) and having an annular slot (14) which accommodates said one or more resting portions (12) and a resting surface (15) facing the lower side (7) and free from metal edges.

The present invention relates to a gas cylinder, i.e. a transportable container used for storing pressurized gas and having a foot for facilitating the stable resting of the cylinder on a surface, e.g. a shelf or a floor.

The cylinders are intended for a variety of uses and the standards for their construction and testing vary according to the application. The main applications of gas cylinders may include storage of liquefied or compressed gases for automotive applications, domestic or industrial uses, storage of compressed or liquefied gases for industrial use, plenum tanks for compressed air, storage of breathable mixtures for breathing apparatuses, storage of medicinal gas, and fire extinguishers.

The known gas cylinders have a cylindrical body with an either concave or convex base and an either semi-spherical or elliptical nose, and a closing valve arranged on the upper part of the cylinder.

Because of their bulging shape, the gas cylinders are often provided with a foot portion which facilitates the resting thereof.

This foot usually consists of an annular or cylindrical portion made of steel welded to the cylinder body and forming a lower “blade-like” annular resting surface, often with sharp edges.

During transportation and use, the gas cylinders are often dragged, rested and moved, whereby the steel foot portion scratches and damages the resting surface underneath or causes injury to the people using the gas cylinder.

Furthermore, when moving the gas cylinders, the knocks and frictions between the foot and the surfaces underneath also result in a deterioration of the outer lining of the cylinder itself.

It is thus the object of the present invention to provide a gas cylinder having features so as to avoid the drawbacks mentioned with reference to the prior art.

These and other objects are achieved by means of a gas cylinder comprising:
a cylinder body internally defining a gas storage space, which can be closed by means of a closing valve, wherein said cylinder body comprises a tubular wall extending along a longitudinal axis, a bottom wall which delimits the gas storage space on a lower side of the cylinder, and an upper wall which delimits the gas storage space on an upper side opposite to the lower side,
a tubular boss formed on the cylinder body to accommodate the closing valve in communication with the gas storage space,
a supporting part made of steel connected to the lower wall and having at least one or more resting portions protruding towards the outside of the gas cylinder,
a protection ring mounted to the supporting part and having an annular groove which accommodates said one or more resting portions, and one or more resting surfaces free from metal edges for a scratch-free resting of the gas cylinder.

The protection ring allows to transport and use the gas cylinder without damaging the surfaces underneath, without damaging the outer lining of the cylinder itself, and without risk of injury for users.

In order to better understand the invention and appreciate the advantages thereof, some non-limitative exemplary embodiments will be described below with reference to the drawings, in which:

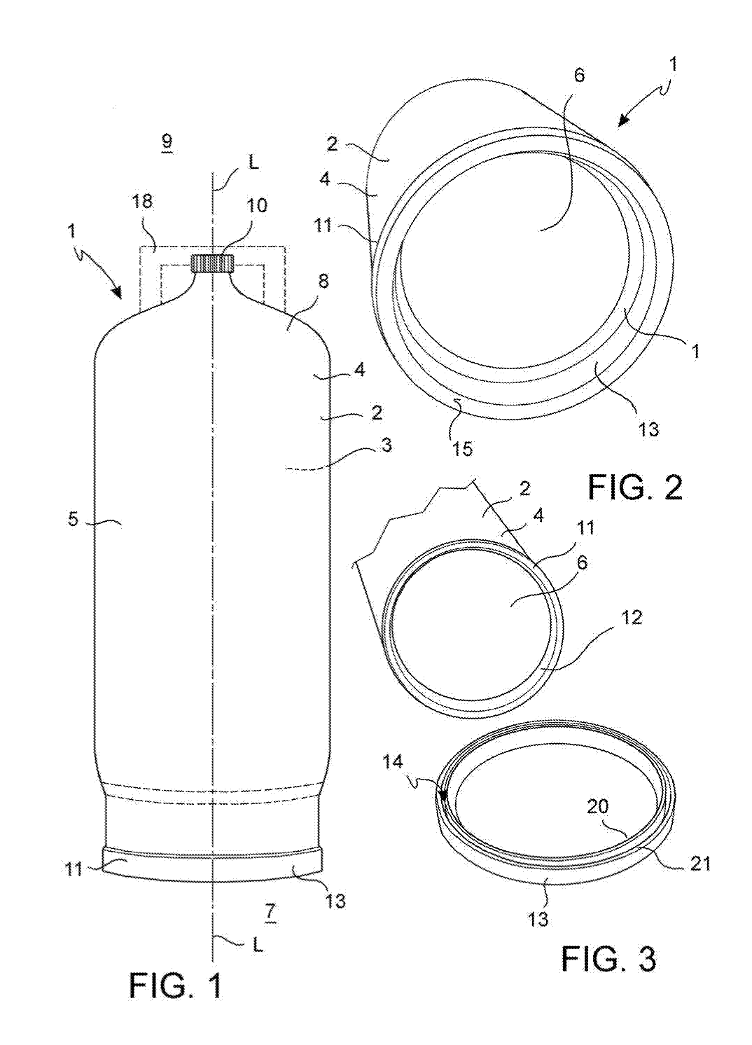

FIG. 1 is a side view of a gas cylinder according to an embodiment of the invention;

FIG. 2 is a bottom perspective view of the gas cylinder in FIG. 1;

FIG. 3 is a partial bottom perspective view of the cylinder in FIG. 1 with a protection ring removed from the cylinder body;

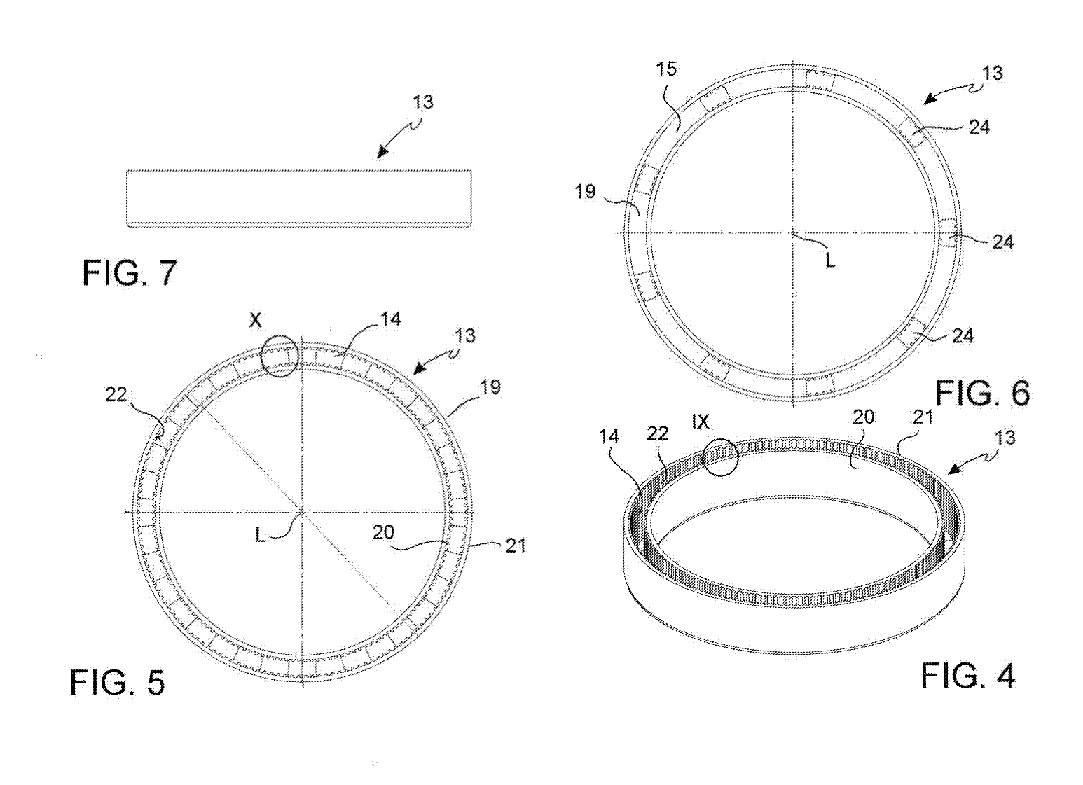

FIG. 4 is a perspective view of a protection ring of a cylinder according to an embodiment;

FIG. 5 is a top view of the protection ring in FIG. 4;

FIG. 6 is a bottom view of the protection ring in FIG. 4;

FIG. 7 is a side view of the protection ring in FIG. 4;

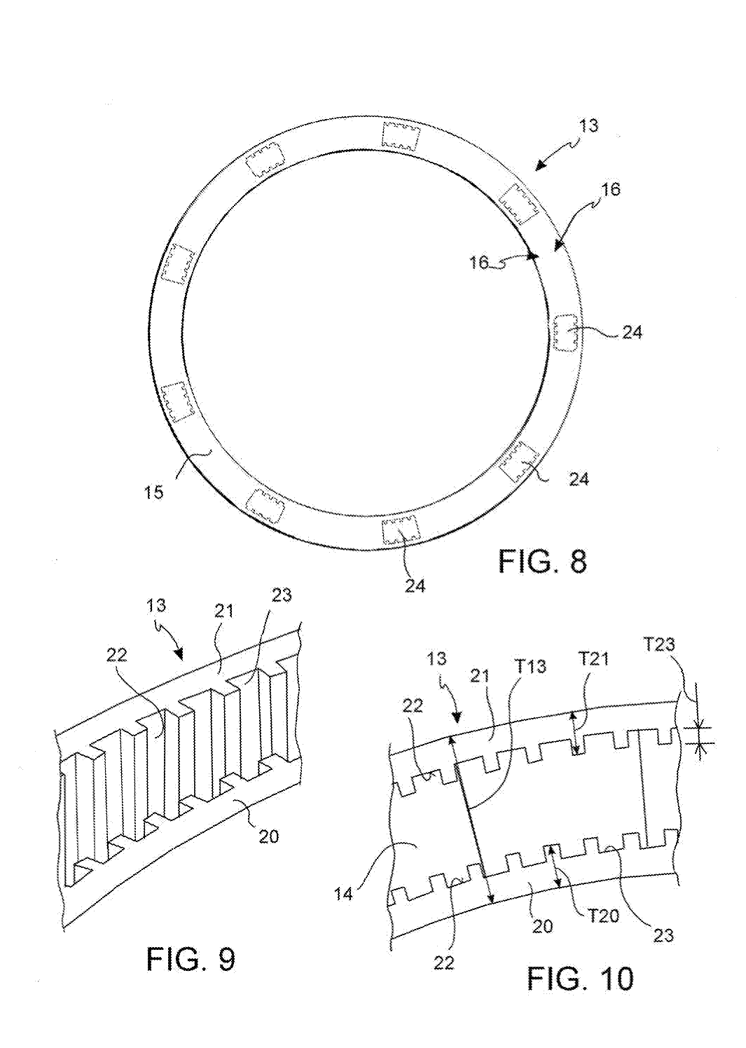

FIG. 8 is a bottom view of a protection ring made of metal material with a smoothed, rounded resting surface according to an embodiment;

FIG. 9 is an enlarged view of detail IX in FIG. 4;

FIG. 10 is an enlarged view of detail X in FIG. 5;

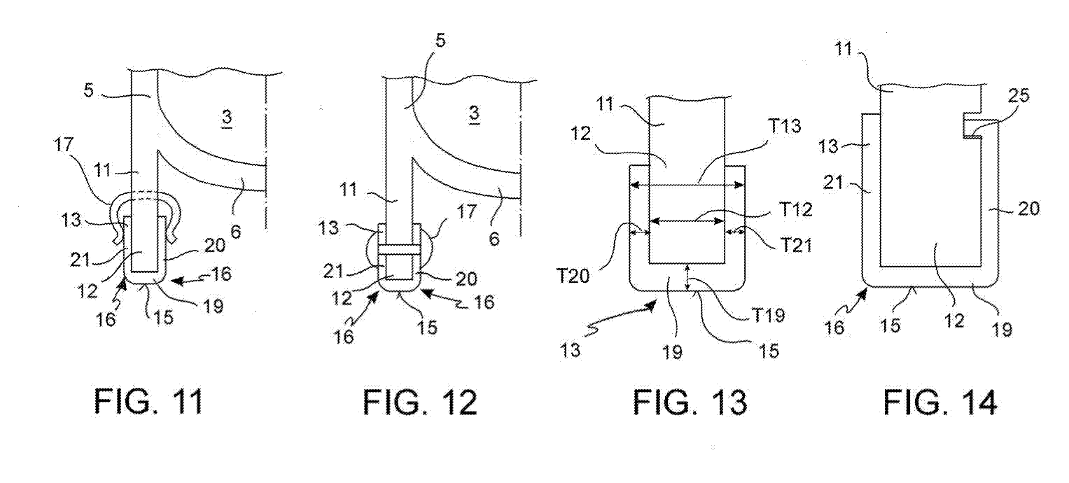

FIGS. 11, 12 and 14 are partial sectional views of details of the gas cylinder according to embodiments;

FIG. 13 indicates some geometric references of the gas cylinder according to the invention.

With reference to the figures, a gas cylinder (hereinafter referred to as “cylinder”) is indicated by reference numeral 1 as a whole. Cylinder 1 comprises a cylinder body 2 internally defining a gas storage space 3, which can be closed by means of a closing valve (not shown in the figures). The cylinder body 2 comprises a tubular wall 5, preferably substantially cylindrical and extending along a longitudinal axis L of cylinder 1, a bottom wall 6, e.g. shaped as a spherical or elliptical cap, which is connected to a lower end of the tubular wall 5 and delimits the gas storage space 3 on a lower side 7 of cylinder 1, as well as an upper wall 8, e.g. ogive-shaped, which is connected to an upper edge of the tubular wall 5 and delimits the gas storage space 3 on an upper side 9 of cylinder 1 opposite to the lower side 7. Cylinder 1 further comprises a threaded tubular boss 10, formed on the cylinder body 2 so as to accommodate (by screwing) the closing valve in communication with the gas storage space 3.

Cylinder 1 further comprises a lower support part (so-called “foot”), preferably made of steel, connected to the lower wall 6 and having at least one or more resting portions 12 protruding towards the outside of the gas cylinder 1, in particular towards the lower side 7.

According to an aspect of the invention, cylinder 1 further comprises a protection ring 13 manufactured separately and then mounted to the supporting part 11 and having an annular slot 14 which accommodates said one or more resting portions 12, and one or more resting surfaces 15 turned or facing towards the lower side 7 and free from metal edges for a scratch-free resting of the gas cylinder 1.

The protection ring 13 allows to transport and use the gas cylinder 1 without damaging the surfaces underneath, without damaging the outer lining of the cylinder itself, and without risk of injury for users.

According to an embodiment, the resting portion 12 is a substantially cylindrical, circular, tubular or annular portion with a lower annular, flat surface 16, which is completely accommodated within the annular slot 14 of the protection ring 13. The entire support part 11 advantageously consists of a circular, cylindrical tubular portion.

The supporting part 11 may be integrally in one piece with or connected to the cylinder body 2 by welding or press-fitting or gluing.

The supporting part is made of metal, preferably of steel. Special embodiments may contemplate making the supporting part 11 of plastic or ceramic material.

The cylinder body 2 is made of metal, preferably of steel, or fiber-reinforced composite material.

The protection ring 13 may be made of plastic, polymeric or elastomeric material. In this case, the plastic or elastic yielding and the relative softness of the protection ring 13 obviate the problem of scratching on the resting surfaces and reduces the risk of injury for the user.

Alternatively, the protection ring 13 may be made of metal, e.g. stainless steel or aluminum, preferably with the smoothed, e.g. polished, resting surface 15 and with rounded and smoothed or rayed lower outer edges 16. If the protection ring 13 has a “U”-shaped profile, the lower outer edges 16 mean the outer side edges of the base of the “U”.

The protection ring 13 (made of metal or plastic) may be press-fitted or friction-fitted on the resting portion 12 using the elasticity of the protection ring 13 as fastening force. In an embodiment, the protection ring 13 forms one or more rims 25 or teeth (or recesses) which engage one or more corresponding rims or teeth (or recesses) of the upper part 11, thus forming extraction-prevention means of the protection ring 13.

Alternatively or in addition to the elastic fastening, the protection ring 13 (made of metal or plastic) may be locked onto the resting portion 12 by means of auxiliary mechanical connection members 17 different from the protection ring 11 and from the resting portion 12, e.g. clamping springs, rivets, screws (FIGS. 11, 12). This reduces the risk of the fastening ring 13 being pulled out from the supporting part 10, e.g. when dragging cylinder 1 along a floor.

Alternatively or in addition to the elastic fastening and/or the mechanical connection members 17, the protection ring 13 (made of metal or plastic) may be locked onto the resting portion 12 by means of gluing, in particular by means of gluing inside the annular slot 14.

In an advantageous embodiment, the adhesive for gluing the protection ring 13 is chosen from epoxy adhesives, e.g. mono- or bi-component, possibly with hot or induction curing.

In a preferred embodiment, the protection ring 13 has a circular shape and a “U-shaped” section profile (on a radial section plane with respect to the longitudinal axis L) with a base wall 19, which forms the resting surface 15, and two side walls 20, 21 (radially inner wall 20, radially outer wall 21, see FIGS. 4, 5), possibly perpendicular to the base wall 19, where at least one of, but preferably both, side walls 20, 21 form a grooved, knurled, undulated or corrugated inner surface 22, preferably with grooves or slots 23 (alternating with ribs) extending from the bottom of the annular slot 14 to its opening facing the cylinder body 1.

The grooves 23 allow a uniform distribution of the glue and its programmed movement out of the slot 14 when inserting the protection ring 13 over the support part 11.

Furthermore, the grooves 23 and the ribs increase the friction between the protection ring 13 and the supporting part 11, also in case of press-fitting.

Using a glue, the grooves 23 form local resting points for the cured glue, thus forming rotation-prevention and extraction-prevention means of the protection ring 13.

Finally, in the absence of glue or in case of partial gluing, the grooves 23 form condensate evacuation and ventilation channels which reduce the risk of interstitial corrosion of the supporting part 11 and/or of the protection ring 13.

The depth T23 of the grooves 23 and, similarly, the height of the ribs is less than 0.15*T13, preferably from 0.125*T13 to 0.085*T13, where T13 is the total radial thickness of the protection ring 13.

At least three, preferably at least four of said grooves 23 per circumferential length unit equal to the total radial thickness T13 of the protection ring 13 are preferably formed in the inner surface 22 in circumferential direction of the protection ring 13.

The grooves 23 advantageously extend parallel to the longitudinal axis L.

In a preferred embodiment, the protection ring 13 forms one or more through openings 24 from the resting surface 15 to the slot 14 (FIGS. 6, 8). These through openings allow, in the case of gluing, to remove the glue in excess and in general to drain the condensate and to visually check the complete insertion of the protection ring 13 on the foot of cylinder 1. The through openings 24 are formed in the bottom wall 19 and distributed uniformly along the circumference of the protection ring 13. However, in order to reduce the exposure of the resting portion 12 as much as possible, the overall opening area Σ A24 of all through openings is less than one third, preferably less than one fourth, of the total area A15 of the resting surface 15.

In an advantageous embodiment, the radial thickness T12 of the tubular wall of the resting portion 12 is greater than the thickness T19 of the bottom wall 19 of the protection ring 13. With further advantage, the radial thickness T12 of the tubular wall of the resting portion 12 is equal to or greater than the single radial thicknesses T20, T21 of the two side walls 20, 21 of the protection ring 13.

Thereby, the support part 11 reinforces and stabilizes the shape, including the outer shape, of the protection ring 13 and of its resting surface 15, despite the relative softness or yielding of the material of the protection ring 13.

As known and shown in FIG. 1, the gas cylinder 1 may have a handle 18 connected to the cylinder body 2 and arranged on the upper side 9 (side of boss 10) of cylinder 1.

Obviously, those skilled in the art may make further changes and variants to the gas cylinder according to the present invention, all without departing from the scope of protection of the invention as defined in the following claims, in order to meet contingent and specific needs.

1. A gas cylinder comprising a cylinder body internally defining a gas storage space which can be closed by means of a closing valve, wherein said cylinder body comprises:
a tubular wall delimiting said gas storage space,
a bottom wall connected to a lower end of the tubular wall and delimiting the gas storage space on a lower side of the cylinder,
an upper wall connected to an upper end of the tubular wall and delimiting the gas storage space on an upper side of the cylinder opposite to the lower side,
a supporting part connected to the lower wall and having one or more resting portions protruding towards the lower side,
a protection ring manufactured separately and then mounted to the supporting part, said protection ring having:
an annular slot, which accommodates said one or more resting portions, and
a resting surface facing the lower side and free from metal edges.

2. A gas cylinder according to claim 1, wherein the resting portion is a substantially circular-cylindrical, tubular portion with an annular and planar lower surface completely accommodated within the annular slot of the protection ring.

3. A gas cylinder according to claim 1, wherein the protective ring is made of plastic, polymeric or elastomeric material.

4. A gas cylinder according to claim 1, wherein:
the protection ring is made of metal, in particular stainless steel or aluminum, and forms rounded lower outer edges,
the resting surface is either smoothed or polished.

5. A gas cylinder according to claim 1, wherein the protection ring is press-fitted on the resting portion by using the elasticity of the protection ring as clamping force.

6. A gas cylinder according to claim 1, wherein the protection ring is locked on the resting portion by means of auxiliary mechanical connection members different from the protection ring and from the resting portion.

7. A gas cylinder according to claim 1, wherein the protection ring is locked on the resting portion by means of an adhesive.

8. A gas cylinder according to claim 1, wherein the protection ring has a circular shape and a “U-shaped” section profile with a base wall which forms the resting surface and two side walls, wherein at least one of the side walls forms a corrugated inner surface with grooves alternating with ribs and extending from the bottom of the annular slot to its opening.

9. A gas cylinder according to claim 8, wherein the depth of the grooves is less than 0.15*T13,
where T13 is the total radial thickness of the protection ring.

10. A gas cylinder according to claim 8, wherein the inner surface forms at least three of said grooves per circumferential length unit equal to the total radial thickness (T13) of the protection ring.

11. A gas cylinder according to claim 8, wherein the grooves extend parallel to the longitudinal axis.

12. A gas cylinder according to claim 1, wherein the protection ring forms a plurality of through openings passing from the resting surface to the slot.

13. A gas cylinder according to claim 12, wherein the overall opening area of all the through openings is smaller than one third of the total area of the resting surface.

14. A gas cylinder according to claim 1, wherein the protection ring has a circular shape and a “U-shaped” section profile with a base wall which forms the resting surface and two side walls,
wherein the radial wall thickness of the resting portion is greater than the thickness of the base wall of the protection ring, and
wherein the radial wall thickness of the resting portion is greater than or equal to the single radial thicknesses of the two side walls.

15. A gas cylinder according to claim 1, comprising a handle connected to the cylinder body and arranged on the upper side of the cylinder.
